(19) United States
(12) Patent Application Publication
(10) Pub. No.: US 2021/0016601 A1
(43) Pub. Date: Jan. 21, 2021

(54) A ROLLING ASSEMBLY

(71) Applicant: Compagnie Generale Des Etablissements Michelin, Clermont-Ferrand (FR)

(72) Inventors: Jacques BABAUD, Tokyo (JP); Kenji FUKUDA, Tokyo (JP)

(21) Appl. No.: 17/042,466

(22) PCT Filed: Mar. 30, 2018
(86) PCT No.: PCT/JP2018/013628

§ 371 Date: Sep. 28, 2020

(51) Int. Cl. B60B 21/12; B60C 15/024

(52) U.S. Cl. CPC B60B 21/12; B60B 21/10; B60C 15/024

(57) ABSTRACT

The rolling assembly has a rotation axis and a rim having rim seats and flanges, an adapter and a tire having beads. The adapter provides the connection between one of the beads and the rim. The rim comprises a portion of a width W extending outwardly from the flange and a connecting introduction portion and a body. The body has a point A that is 10% of W axially inward from an axially outermost of the body or from an axially outermost of the adapter. The portion creates a virtual straight line GD between an innermost of the connecting introduction portion and the point A. The portion and the adapter has a radial distance d at the point A. The body has a maximum radial distance e from the virtual straight line GD at axially inward from the point A, and the body has no contact with the adapter.

### CROSS-REFERENCE TO RELATED APPLICATIONS

This application claims priority to and the benefit of PCT Patent Application No. PCT/JP2018/013628, filed Mar. 30, 2018, entitled “A ROLLING ASSEMBLY.”

### BACKGROUND OF THE INVENTION

### 1. Technical Field

The present disclosure relates to a rim for a vehicle including a seat for receiving a tire bead is radially floating. The present disclosure relates in particular systems containing flexible adapter inserted between a tire bead and a rim.

A tire, a rim, an adapter, referred to in the present disclosure, objects are usually described by a representation in a meridian plane, that is to say a plane containing a rotation axis (an axis of rotation) of the tire. All these products (a tire, a rim and an adapter) are objects having geometry of revolution relative to their axis of rotation.

### 2. Related Art

A tire currently used these days mainly comprises a tread intended to provide contact with ground, this tread generally being reinforced by a crown reinforcement which is positioned radially inward of the tread. The crown reinforcement is able to give the crown the rigidities, in the three dimensions, which needs for the running of the tire.

The crown reinforcement also limits the radial expansion of a carcass reinforcement, generally made up of one or more plies of radial reinforcing elements. When the tire is mounted so as to become functional, it contains an inflation gas, inflated to a nominal pressure. The carcass reinforcement, during the use of the tire within reasonable limits, deforms both statically and when running. The carcass reinforcement is generally anchored in each bead to a reinforcing ring. The beads provide contact with the seat and flange of the rim on which the tire is mounted.

Transmission of mechanical load between the tire and the rim, which load is the result of the inflation, compression and running of the tire, and sealing of this tire are provided by the distribution and the magnitude of the forces of contact between the bead and the rim seats and rim flanges. Good tire behavior both from the standpoint of endurance and from the standpoint of the properties conferred on the vehicle equipped with it, and a good mounting rim quality/price ratio have led to the adoption of a ratio of rim width to maximum axial tire width of around 0.7. It is known that this ratio is merely a compromise and that a certain number of tire properties, for example road holding are improved by the use of a rim allowing a higher ratio; conversely, other properties can be improved, of course at the expense of the former properties, by mounting on a narrow rim, namely by having a ratio, as defined hereinabove, of around 0.40 or less.

WO00/078565 discloses a rolling assembly having an elastic adapter inserted between a rim and beads of a tire. This adapter is elastically deformable in the radial and axial directions. Such an adapter makes it possible to separate that part of the rolling assembly that can be considered to actually act as a tire from that part of the rolling assembly that can be considered to act as a rim.

WO2015/091620 discloses an adapter for a rolling assembly comprising a tire and a rim, the adapter providing a connection between the rim and a bead of the tire, the adapter comprising an axially inner end comprising an inner reinforcer element, an axially outer end comprising an outer reinforcer element, a body connecting the outer end and the inner end as to form a single piece and comprising at least one main reinforcement for reducing level of mechanical forces towards chassis in an event of an impact while maintaining a very good ability to withstand curb impact.

These solutions improve interior noise performance by shifting tire vibration mode frequency lower. However with these solutions steering improvement is not yet satisfactory while maintaining, even improving interior noise performance and/or ability to withstand curb impact.

### Citation List

### Patent Literature

PTL 1: WO00/078565

### PTL 2: WO2015/091620

Therefore, there is a need for a rolling assembly which improves steering of a vehicle simultaneously with satisfactory interior noise performance and/or ability to withstand curb impact.

Definitions:

A “radial direction/orientation” is a direction/orientation perpendicular to axis of rotation of the tire. This direction/orientation corresponds to thickness orientation of the tread.

An “axial direction/orientation” is a direction/orientation parallel to axis of rotation of the tire.

A “circumferential direction/orientation” is a direction/orientation which is tangential to any circle centered on axis of rotation. This direction/orientation is perpendicular to both the axial direction/orientation and the radial direction/orientation.

An “equatorial plane” is a plane perpendicular to the axis of rotation and passing through middle of a tread.

An “inflation state” is a state in which a rolling assembly is inflated to its nominal pressure corresponding to a tire dimension in the rolling assembly as defined in tire standards such as ETRTO, JATMA or TRA.

### SUMMARY OF INVENTION

It is thus an object of the present disclosure to provide a rolling assembly comprising a tire, a rim and one adapter, such the rolling assembly can provide improvement on steering of a vehicle simultaneously with satisfactory interior noise performance and/or ability to withstand curb impact.

The present disclosure provides a rolling assembly having a rotation axis and comprising a rim having two rim seats being axially outwardly extended by rim flanges, at least one adapter and a tire having two beads, the at least one adapter providing the connection between one of the beads and the rim, the at least one adapter comprising an axially inner end that is adapted to be mounted on one of the rim seats, an axially outer end that is adapted to receive one of the beads and an adapter body connecting the axially inner end and the axially outer end as to form a single piece, the rim comprises at least one extending portion of an axial width W extending axially outwardly from the rim flange and consisting of at least a connecting introduction portion and an extending body, the extending body having a point A that is 10% of the axial width W of the extending portion axially inward from an axially outermost of the extending body or from an axially outermost of the adapter whichever locates axially inward, the extending portion creating a virtual straight line GD between an axially innermost of the connecting introduction portion and the point A, the extending portion and the adapter has a radial distance d at the point A, the extending body has a maximum radial distance e from the virtual straight line GD at axially inward from the point A, and the extending body has no contact with the at least one adapter at inflation state.

This arrangement provides improvement on steering of a vehicle while maintaining satisfactory interior noise performance and/or ability to withstand curb impact.

Since the adapter providing the connection between one of the beads and the rim, the adapter can deform at least in radial and in axial directions, thus it is possible to improve comfort and ability to withstand curb impact. The adapter also makes it possible to improve interior noise performance by shifting vibration mode frequency lower.

Since the rim comprises at least one extending portion of an axial width W extending axially outwardly from the rim flange and consisting of at least a connecting introduction portion and an extending body, and the extending body has no contact with the at least one adapter at inflation state, the extending body of the extending portion is able to receive the adapter deformed due to excessive load, it is possible to improve steering of a vehicle while maintaining improvement on comfort, ability to withstand curb impact and interior noise performance under usual loading condition in which the adapter being supposed not in contact with the extending body of the extending portion.

Since the extending body having a point A that is 10% of the axial width W of the extending portion axially inward from an axially outermost of the extending body or from an axially outermost of the adapter whichever locates axially inward, the extending portion creating a virtual straight line GD between an axially innermost of the connecting introduction portion and the point A, the extending portion and the adapter has a radial distance d at the point A, the extending body has a maximum radial distance e from the virtual straight line GD at axially inward from the point A, it is possible to avoid contacting the adapter with the extending body of the extending portion of the rim during non-excessive loading condition in which the adapter being supposed not in contact with for securing deformation of the adapter thus improvements on comfort, ability to withstand curb impact and interior noise performance are maintained. Thanks to the maximum radial distance e from the virtual straight line GD at axially inward from the point A with the extending body, the extending body can receive the adapter deformed during excessive loading.

In another preferred embodiment, the rolling assembly comprises two adapters, to and the rim comprises two extending portions extending axially outwardly from the rim flange.

According to this arrangement, it is possible to improve steering of a vehicle while maintaining improvement on comfort, ability to withstand curb impact and interior noise performance under usual loading condition in which the adapter being supposed not in contact with the extending body of the extending portion more certainly as the extending body of the extending portion placed axially outward is able to receive the adapter placed axially outward, and the extending body of the extending portion placed axially inward is able to receive the adapter placed axially inward, both deformed due to excessive load.

In another preferred embodiment, an axially outermost position of the extending portion locates axially inward of an axially outermost position of the adapter.

According to this arrangement, it is possible to prevent the extending portion of the rim contacting directly to a curb or the like, as a result damage to the rim can be prevented.

In another preferred embodiment, the axially outermost of the extending portion locates axially inward of the bead.

According to this arrangement, it is possible to prevent further the extending portion of the rim contacting directly to a curb or the like, as a result damage to the rim can further be prevented.

In another preferred embodiment, the axial width W is at least equal to 30% of an axial width of the adapter axially outwardly from the rim flange.

If the axial width W of the extending portion of the rim is less than 30% of the axial width of the adapter axially outwardly from the rim flange, there is a risk that the extending portion of the rim cannot receive fully the adapter deformed due to excessive load. As a result improvement on steering of a vehicle would not be satisfactory. By setting this axial width W of the extending portion of the rim at least equal to 30% of the axial width of the adapter axially outwardly from the rim flange, it is possible to improve steering of a vehicle while maintaining improvement on comfort, ability to withstand curb impact and interior noise performance under usual loading condition in which the adapter being supposed not in contact with the extending body of the extending portion.

The axial width W of the extending portion of the rim is preferably at least equal to 40% of the axial width of the adapter axially outwardly form the rim flange, more preferably at least equal to 50% of the axial width of the adapter axially outwardly form the rim flange and still more preferably at least equal to 60% and at most equal to 95% of the axial width of the adapter axially outwardly form the rim flange.

In another preferred embodiment, the virtual straight line GD is extending axially downwardly from the axially innermost of the connecting introduction portion.

If the virtual straight line GD is not extending axially downwardly from the axially innermost of the connecting introduction portion, there is a risk that the adapter touches too soon to the extending body of the extending portion during load transfer even at the load in which the adapter being supposed not in contact with. As a result comfort, ability to withstand curb impact or interior noise performance under usual loading condition is degraded. By setting this virtual straight line GD extending axially downwardly from the axially innermost of the connecting introduction portion, it is possible to improve steering of a vehicle while maintaining improvement on comfort, ability to withstand curb impact and interior noise performance under usual loading condition in which the adapter being supposed not in contact with the extending body of the extending portion.

In another preferred embodiment, the maximum radial distance e is less than or equal to 80% of the radial distance d.

If this maximum radial distance e is more than 80% of the radial distance d, there is a risk that the adapter does not contact with the extending body of the extending portion of the rim even under excessive load. As a result, steering of a vehicle cannot be improved. By setting this maximum radial distance e being less than or equal to 80% of the radial distance d, it is possible to improve steering of a vehicle while maintaining improvement on comfort, ability to withstand curb impact and interior noise performance under usual loading condition in which the adapter being supposed not in contact with the extending body of the extending portion. This configuration also allows flexibility of a shape of the extending body of the extending portion.

The maximum radial distance e is preferably less than or equal to 75% of the radial distance d, more preferably less than or equal to 70% of the radial distance d.

### Advantageous Effects Of Invention

According to the arrangements described above, it is possible to provide improvement on steering of a vehicle while maintaining satisfactory interior noise performance and/or ability to withstand curb impact.

### BRIEF DESCRIPTION OF DRAWINGS

Other characteristics and advantages of the disclosure arise from the description made hereafter in reference to the annexed drawings which show, as nonrestrictive examples, the embodiment of the disclosure.

In these drawings:

FIG. 1 is a schematic sectional view of a rolling assembly according to a first embodiment of the present disclosure;

FIG. 2 is a schematic sectional view of a portion of a rim of the rolling assembly according to the first embodiment of the present disclosure;

FIG. 3 is a schematic sectional view of a rolling assembly according to a second embodiment of the present disclosure; and

FIG. 4 is a schematic sectional view of a rolling assembly according to prior art.

### DESCRIPTION OF EMBODIMENTS

Preferred embodiments of the present disclosure will be described below referring to the drawings.

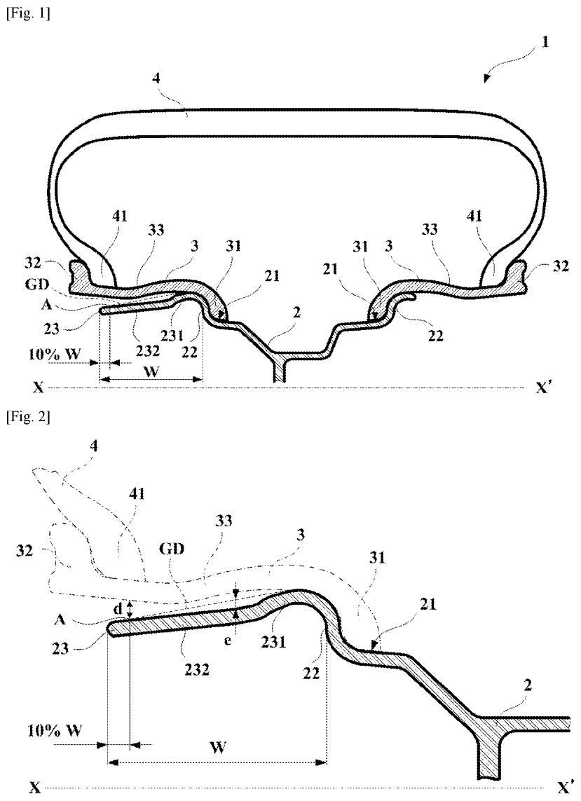

A rolling assembly 1 according to a first embodiment of the present disclosure will be described referring to FIGS. 1 and 2.

FIG. 1 is a schematic sectional view of a rolling assembly according to a first embodiment of the present disclosure. FIG. 2 is a schematic sectional view of a rim of the rolling assembly according to the first embodiment of the present disclosure.

The rolling assembly 1 is a rolling assembly having a rotation axis XX′ where X is a direction intended to be outside when the rolling assembly 1 being mounted onto a vehicle, thus X′ is a direction intended to be inside when the rolling assembly 1 being mounted onto a vehicle, and comprising a rim 2 having two rim seats 21 being axially outwardly extended by rim flanges 22, two adapters 3 and a tire 4 having two beads 41, each the adapter 3 providing the connection between one of the bead 41 and the rim 2. In this FIG. 1, the rolling assembly 1 is in an inflation state.

The adapter 3 comprising an axially inner end 31 that is adapted to be mounted on one of the rim seats 21, an axially outer end 32 that is adapted to receive one of the beads 41 and an adapter body 33 connecting the axially inner end 31 and the axially outer end 32 as to form a single piece.

As shown in FIG. 1, on a side intended to be outside when the rolling assembly 1 being mounted onto a vehicle of the rim 2, an extending portion 23 of an axial width W extending axially outwardly from the rim flange 22 is provided. The extending portion 23 is consisting of a connecting introduction portion 231 extending from the rim flange 22 as to extend a curvature of the rim flange 22 and an extending body 232 extending from axially outward of the connecting introduction portion 231 in a straight form. An axially innermost of the connecting introduction portion 231 locates at a position where the rim flange 22 has a maximum diameter.

As shown in FIG. 2, the extending portion 23 creating a virtual straight line GD between an axially innermost of the connecting introduction portion 231 and a point A that is on the extending body 232 of the extending portion 23 and 10% of the axial width W of the extending portion 23 axially inward from an axially outermost of the extending body 232 or from an axially outermost of the adapter 3 whichever locates axially inward. The extending portion 23 and the adapter 3 has a radial distance d at the point A. The extending body 232 has a maximum radial distance e from the virtual straight line GD at axially inward from the point A, and the extending body 232 has no contact with the at least one adapter 3 at inflation state.

As shown in FIG. 2, an axially outermost of the extending portion 23 locates axially inward of an axially outermost of the adapter 3, and also the axially outermost of the extending portion 23 locates axially inward of the bead 41 of the tire 4.

The axial width W of the extending portion 23 is at least equal to 30% of an axial width of the adapter 3 axially outwardly from the rim flange 22.

The virtual straight line GD is extending axially downwardly from the axially innermost of the connecting introduction portion 231.

The maximum radial distance e is less than or equal to 80% of the radial distance d.

Since the adapter 3 providing the connection between one of the beads 41 and the rim 2, the adapter 3 can deform at least in radial and in axial directions, thus it is possible to improve comfort and ability to withstand curb impact. The adapter 3 also makes it possible to improve interior noise performance by shifting vibration mode frequency lower.

Since the rim 2 comprises at least one extending portion 23 of an axial width W extending axially outwardly from the rim flange 22 and consisting of at least a connecting introduction portion 231 and an extending body 232, and the extending body 232 has no contact with the at least one adapter 3 at inflation state, the extending body 232 of the extending portion 23 is able to receive the adapter 3 deformed due to excessive load, it is possible to improve steering of a vehicle while maintaining improvement on comfort, ability to withstand curb impact and interior noise performance under usual loading condition in which the adapter 3 being supposed not in contact with the extending body 232 of the extending portion 23.

Since the extending body 232 having a point A that is 10% of the axial width W of the extending portion 23 axially inward from an axially outermost of the extending body 232 or from an axially outermost of the adapter 3 whichever locates axially inward, the extending portion 23 creating a virtual straight line GD between an axially innermost of the connecting introduction portion 231 and the point A, the extending portion 23 and the adapter 3 has a radial distance d at the point A, the extending body 232 has a maximum radial distance e from the virtual straight line GD at axially inward from the point A, it is possible to avoid contacting the adapter 3 with the extending body 232 of the extending portion 23 of the rim 2 during non-excessive loading condition in which the adapter being supposed not in contact with for securing deformation of the adapter 3 thus improvements on comfort, ability to withstand curb impact and interior noise performance are maintained. Thanks to the maximum radial distance e from the virtual straight line GD at axially inward from the point A with the extending body 232, the extending body 232 can receive the adapter 3 deformed during excessive loading.

Since an axially outermost position of the extending portion 23 locates axially inward of an axially outermost position of the adapter 3, it is possible to prevent the extending portion 23 of the rim 2 contacting directly to a curb or the like, as a result damage to the rim 2 can be prevented.

Since the axially outermost of the extending portion 23 locates axially inward of the bead 41, it is possible to prevent further the extending portion 23 of the rim 2 contacting directly to a curb or the like, as a result damage to the rim 2 can further be prevented.

Since the axial width W is at least equal to 30% of an axial width of the adapter 3 axially outwardly from the rim flange 22, it is possible to improve steering of a vehicle while maintaining improvement on comfort, ability to withstand curb impact and interior noise performance under usual loading condition in which the adapter 3 being supposed not in contact with the extending body 232 of the extending portion 23.

If the axial width W of the extending portion 23 of the rim 2 is less than 30% of the axial width of the adapter 3 axially outwardly from the rim flange 22, there is a risk that the extending portion 23 of the rim 2 cannot receive fully the adapter 3 deformed due to excessive load. As a result improvement on steering of a vehicle would not be satisfactory.

The axial width W of the extending portion 23 of the rim 2 is preferably at least equal to 40% of the axial width of the adapter 3 axially outwardly form the rim flange 22, more preferably at least equal to 50% of the axial width of the adapter 3 axially outwardly form the rim flange 22 and still more preferably at least equal to 60% and at most equal to 95% of the axial width of the adapter 3 axially outwardly form the rim flange 22.

Since the virtual straight line GD is extending axially downwardly from the axially innermost of the connecting introduction portion 231, it is possible to improve steering of a vehicle while maintaining improvement on comfort, ability to withstand curb impact and interior noise performance under usual loading condition in which the adapter 3 being supposed not in contact with the extending body 232 of the extending portion 23.

If the virtual straight line GD is not extending axially downwardly from the axially innermost of the connecting introduction portion 231, there is a risk that the adapter 3 touches too soon to the extending body 232 of the extending portion 23 during load transfer even at the load in which the adapter 3 being supposed not in contact with. As a result comfort, ability to withstand curb impact or interior noise performance under usual loading condition is degraded.

Since the maximum radial distance e is less than or equal to 80% of the radial distance d, it is possible to improve steering of a vehicle while maintaining improvement on comfort, ability to withstand curb impact and interior noise performance under usual loading condition in which the adapter 3 being supposed not in contact with the extending body 232 of the extending portion 23. This configuration also allows flexibility of a shape of the extending body 232 of the extending portion 23.

If this maximum radial distance e is more than 80% of the radial distance d, there is a risk that the adapter 3 does not contact with the extending body 232 of the extending portion 23 of the rim 2 even under excessive load. As a result, steering of a vehicle cannot be improved.

The maximum radial distance e is preferably less than or equal to 75% of the radial distance d, more preferably less than or equal to 70% of the radial distance d.

The rim 2 is preferably made of a material selected from steel or alloys of aluminum and/or magnesium, composite materials based on carbon fiber, glass fiber, aramid fiber, plant fiber, the said fibers being contained within a matrix based on thermosetting or thermoplastic compounds, or from a complex composite comprising an elastomer and a complex based on resin and fibers selected from carbon fibers, glass fibers, aramid fibers, plant fibers or any combinations of materials.

The matrix based on thermosetting compounds is selected from epoxy resins, vinylester, unsaturated polyesters, ester cyanate, bismaleimide, acrylic resins, phenolic resins, polyurethanes and combinations thereof.

The matrix based on thermoplastic compounds is selected from polypropylene (PP), polyethylene (PE), polyamides (PA), semiaromatic polyamides, polyester (PET), polybutylene terephthalate (PBT), polyetheretherketone (PEEK), polyetherketoneketone (PEKK), polyethersulphone (PSU), polyetherimide (PEI), polyimide (P1), polyamidelmide (PAl), polyphenylenesulphide (PPS), polyoxymethylene (POM), polyphenylene oxide (PPO).

The adapter 3 may be any kind being elastically deformable in the two, radial and axial, directions known to those skilled in the art. The adapter 3 may include an adapter bead (not shown) in the inner end 31 of the adapter 3 intended to catch the adapter 3 on top of the rim flange 22 of the rim 2, as being done conventionally by the bead 41 of the tire 4. The outer end 32 of the adapter 3 which accepts the bead 41 of the tire 4 in exactly the same way as the top of the rim flange 22 of the rim 2 conventionally does. The outer end 32 of the adapter 3 may also include an adapter bead (not shown), which may be the same or different with the adapter bead included in the inner end 31 of the adapter 3.

The adapter 3 may be made of elastomers such as rubbers that can be crosslinked by chemical vulcanization reactions by sulfur bridges, by carbon-carbon bonds created by the action of peroxides or of ionizing radiation, by other specific atom chains of the elastomer module, thermoplastic elastomers (TPEs) in which the elastically deformable part forms a network between rather non-deformable “hard” regions, the cohesion of which is the product of physical connections (crystallites or amorphous regions above their glass transition temperature), non-thermoplastic elastomers and thermoset resins. The adapter 3 may also include a plurality of reinforcement along the inner end 31, adapter body 33 and the outer end 32, which may be made of metal (for example steel) cords or textile cords (for example rayon, aramid, polyethylene, nylon, glass fiber, carbon fiber, basalt fiber, PEN or PVA).

A form of the extending body 232 of the extending portion 23 may be in straight, curve, combination of several curves or combination of these forms.

At an axially outermost of the extending body 232 of the extending portion 23, a part in a form that reinforces the extending portion 23 may be provided.

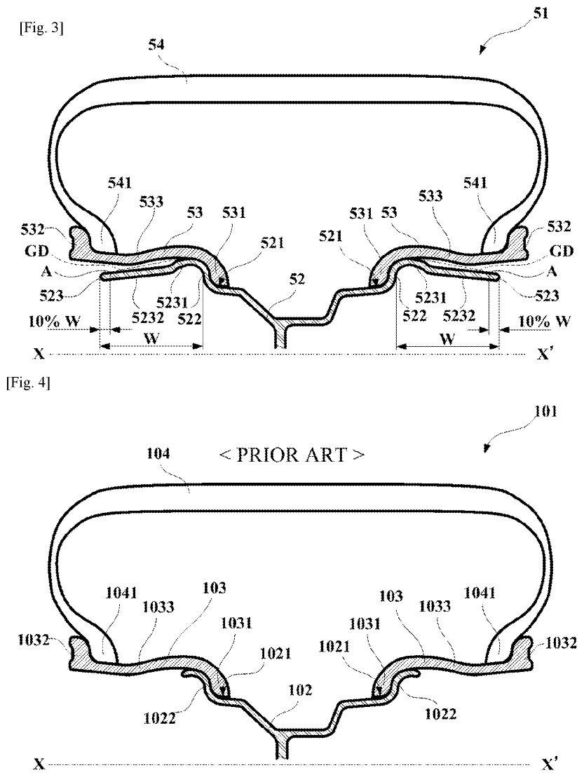

A rolling assembly 51 according to a second embodiment of the present disclosure will be described referring to FIG. 3. FIG. 3 is a schematic sectional view of a rolling assembly according to a second embodiment of the present disclosure. The construction of this second embodiment is similar to that of the first embodiment other than the arrangement shown in FIG. 3, thus description will be made referring to FIG. 3.

As shown in FIG. 3, the rolling assembly 51 is a rolling assembly having a rotation axis XX′ where X is a direction intended to be outside when the rolling assembly 51 being mounted onto a vehicle, thus X′ is a direction intended to be inside when the rolling assembly 51 being mounted onto a vehicle, and comprising a rim 52 having two rim seats 521 being axially outwardly extended by rim flanges 522, two adapters 53 and a tire 54 having two beads 541, each the adapter 53 providing the connection between one of the bead 541 and the rim 52.

The adapter 53 comprising an axially inner end 531 that is adapted to be mounted on one of the rim seats 521, an axially outer end 532 that is adapted to receive one of the beads 541 and an adapter body 533 connecting the axially inner end 531 and the axially outer end 532 as to form a single piece.

As shown in FIG. 3, on axially both sides two extending portions 523 of each an axial width W extending axially outwardly from the rim flange 522 are provided. Each the extending portion 523 is consisting of a connecting introduction portion 5231 extending from the rim flange 522 as to extend a curvature of the rim flange 522 and an extending body 5232 extending from axially outward of the connecting introduction portion 5231 in a straight form. An axially innermost of the connecting introduction portion 5231 locates at a position where the rim flange 522 has a maximum diameter.

Since the rolling assembly 51 comprises two adapters 53, and the rim 52 comprises two extending portions 523 extending axially outwardly from the rim flange 522, it is possible to improve steering of a vehicle while maintaining improvement on comfort, ability to withstand curb impact and interior noise performance under usual loading condition in which the adapter 53 being supposed not in contact with the extending body 5232 of the extending portion 523 more certainly as the extending body 5232 of the extending portion 523 placed axially outward is able to receive the adapter 53 placed axially outward, and the extending body 5232 of the extending portion 523 placed axially inward is able to receive the adapter 53 placed axially inward, both deformed due to excessive load.

The disclosure is not limited to the examples described and represented and various modifications can be made there without leaving its framework.

FIG. 4 is a schematic sectional view of a rolling assembly 101 according to prior art. In this FIG. 4, the rolling assembly 101 having a rotation axis XX′ where X is a direction intended to be outside when the rolling assembly 101 being mounted onto a vehicle, thus X′ is a direction intended to be inside when the rolling assembly 101 being mounted onto a vehicle, and comprising a rim 102 having two rim seats 1021 being axially outwardly extended by rim flanges 1022, two adapters 103 and a tire 104 having two beads 1041, the adapter 103 providing the connection between one of the bead 1041 and the rim 102. The rim 102 of the rolling assembly 101 stops extending axially at the rim flanges 1022.

The adapter 103 comprising an axially inner end 1031 that is adapted to be mounted on one of the rim seats 1021, an axially outer end 1032 that is adapted to receive one of the beads 1041 and an adapter body 1033 connecting the axially inner end 1031 and the axially outer end 1032 as to form a single piece.

### REFERENCE SIGNS LIST

1, 51 rolling assembly
2, 52 rim
21, 521 rim seat
22, 522 rim flange
23, 523 extending portion
231, 5231 connecting introduction portion
232, 5232 extending body
3, 53 adapter
31, 531 inner end of adapter
32, 532 outer end of adapter
33, 533 adapter body
4, 54 tire
41, 541 bead

What is claimed is:

1. A rolling assembly having a rotation axis and comprising a rim having two rim seats being axially outwardly extended by rim flanges, at least one adapter and a tire having two beads, the at least one adapter providing the connection between one of the beads and the rim, the at least one adapter comprising an axially inner end that is adapted to be mounted on one of the rim seats, an axially outer end that is adapted to receive one of the beads and an adapter body connecting the axially inner end and the axially outer end as to form a single piece,
the rim comprising at least one extending portion of an axial width W extending axially outwardly from the rim flange and consisting of at least a connecting introduction portion and an extending body, the extending body having a point A that is 10% of the axial width W of the extending portion axially inward from an axially outermost of the extending body or from an axially outermost of the adapter whichever locates axially inward, the extending portion creating a virtual straight line GD between an axially innermost of the connecting introduction portion and the point A, the extending portion and the adapter has a radial distance d at the point A, and wherein the extending body has a maximum radial distance e from the virtual straight line GD at axially inward from the point A, and wherein the extending body has no contact with the at least one adapter at inflation state.

2. The rolling assembly according to claim 1, wherein the at least one extending portion positions on a side intended to be outside when the rolling assembly being mounted onto a vehicle.

3. The rolling assembly according to claim 1, wherein the rolling assembly comprises two adapters, and wherein the rim comprises two extending portions extending axially outwardly from the rim flange.

4. The rolling assembly according to claim 1, wherein an axially outermost of the extending portion locates axially inward of an axially outermost of the adapter.

5. The rolling assembly according to claim 4, wherein the axially outermost of the extending portion locates axially inward of the bead.

6. The rolling assembly according to claim 1, wherein the axial width W is at least equal to 30% of an axial width of the adapter axially outwardly from the rim flange.

7. The rolling assembly according to claim 1, wherein the virtual straight line GD is extending axially downwardly from the axially innermost of the connecting introduction portion.

8. The rolling assembly according to claim 1, wherein the maximum radial distance e is less than or equal to 80% of the radial distance d.
